(19) United States
(12) Patent Application Publication
(10) Pub. No.: US 2020/0115294 A1
(43) Pub. Date: Apr. 16, 2020

(54) Nutrient Additive

(71) Applicant: Elemental Digest Limited, Exeter (GB)

(72) Inventor: Adrian James Guy, Exeter (GB)

(73) Assignee: Elemental Digest Limited, Exeter (GB)

(21) Appl. No.: 16/477,611

(22) PCT Filed: Jan. 16, 2018
(86) PCT No.: PCT/GB2018/050115

§ 371 Date: Jul. 12, 2019

(30) Foreign Application Priority Data
Jan. 16, 2017 (GB) 1700713.9

(51) Int. Cl. C05F 9/00; C05D 9/02

(52) U.S. Cl. CPC C05F 9/00; C05G 3/0058; C05D 9/02

(57) ABSTRACT

The invention related to a method of making a nutrient additive from electronic waste comprising the steps of: a) adding electronic waste to a reaction vessel; b) admixing the electronic waste and optionally one or more metal catalysts with one or more acids, wherein one or more metals in the electronic waste is dissolved by the acid to form a nutrient additive; and related products, such as fertilisers and soil improvers.

### CROSS REFERENCE TO RELATED APPLICATIONS AND CLAIM TO PRIORITY:

This Application is a national stage application of International Application No. PCT/GB2018/050115, filed Jan. 16, 2018, which claims priority to United Kingdom Application No. 1700713.9, filed Jan. 16, 2017, which applications are herein incorporated by reference in their entireties and to which priority is claimed.

The present invention relates to a method of making fertilizers and soil improvers by dissolving electronic waste in strong acid; which involves a metal catalysed reaction between the electronic waste and acid. The present invention also relates to a fertilizer or soil improver additive made by methods of the present invention to increase mineral nutrients recovered from electronic waste.

Batteries, electrical waste and electronic waste (herein referred to as “electronic waste”) such as circuit boards are traditionally considered difficult to dispose of because they contain a variety of metals and acids that can be toxic to the environment. Previously, the majority of electronic waste, including batteries, was sent to land-fill or it was incinerated, which could potentially cause soil, air or water pollution. In recent years many countries have put in place legislation or processes to ensure recycling of such electronic waste.

Electronic waste, such as batteries, contain an abundance of metals including manganese, cobalt, iron, zinc, copper, silver, and potassium, which are increasingly valuable. This has led to an increase in recycling of electronic waste to separate out metals so that they can be re-used.

Recycling of electronic waste is often done by a multi-step process including sorting and dismantling the electronic waste, such as batteries, mechanical processing, magnetic separation of ferrous metals, eddy current separation of non-ferrous metals and separation of plastics. Metal components are often separated using hydrometallurgical and pyrometallurgical techniques, which may be followed by chemical processes for separating and purifying the metals. Pyrometallurgical techniques require high temperatures and can only be carried out in specialised facilities such as blast-furnaces and smelters. These processes are complex, time-consuming, expensive, and often use toxic chemicals. It is also technically difficult to ensure no pollutants are emitted into the environment when carrying out these techniques.

Nutrients are being depleted in agricultural soils due to modern day, intensive agricultural practices. Redressing nutrient levels in soils is a costly and time consuming exercise for farmers, which requires specialist fertilizers and/or nutrient and/or trace element dressings.

Soil health is vital in providing nutritious crops and livestock from which food is derived. Modern, western diets are becoming increasingly calorific and at the same time nutrient deficient because of low soil nutrient levels.

It would be advantageous to provide a rapid, efficient, cheap and convenient source of nutrients, in particular metals and metal ions, which can be used to enrich agricultural soils that have become depleted by intensive agriculture. It would also be advantageous to provide a cheap and convenient method of recycling electronic waster, for example batteries, electronic waste and electrical waste.

According to a first aspect the present invention provides a method of making a nutrient additive from electronic waste comprising the steps of:
a) adding electronic waste to a reaction vessel;
b) admixing the electronic waste with one or more acids, and optionally one or more metal catalysts,
   wherein one or more metals in the electronic waste is dissolved by the acid to form a nutrient additive.

In one embodiment a metal catalyst is mixed with the electronic waste and the one or more acids. The catalyst can increase the rate of reaction and may also contribute metal ions and metal compounds to the nutrient additive.

The method may further comprise one or more, or all, of the following steps:
c) a separation step, to remove acid-insoluble plastic;
d) adjusting the acidity by further additions of acids or alkalis where required;
e) diluting the mixture;
f) concentrating the mixture, for example by evaporation;
g) adding the nutrient additive to liquid ingredients, for example to form a slurry additive, fertiliser additive or soil improver additive;
h) adding the nutrient additive to dry ingredients, for example to form a slurry additive, fertiliser additive or soil improver additive;
i) adding the nutrient additive to liquid ingredients, for example to form a fertiliser or soil improver;
j) adding the nutrient additive to dry ingredients, for example to form a fertiliser or soil improver;
k) setting the nutrient additive and optionally additional ingredients, by adding a setting agent. The setting agent may be selected from gelatine, agar, gypsum and lime, or combinations thereof.

The nutrient additive of the present invention may be a slurry additive, fertiliser additive or soil improver additive. The nutrient additive of the present invention may also be used to add nutrients to slurry pits or other organic wastes such as farm yard manure, pig water, compost waste, chicken litter, dung heaps, human sewage, animal by-products, domestic food waste, water treatment solid wastes, dog excrement bags, for example by dosing of the storage pits or tanks; prior to land application as fertilisers and/or soil improvers.

The method of the present invention may provide a nutrient additive, for example a slurry additive, fertiliser, fertiliser additive, soil improver, or soil improver additive made by the method of the present invention. The nutrient additive may be in the form of a solution, gel or dried preparation such as a powder, granules or pellets. The nutrient additive may be added to further ingredients to form an enriched fertiliser or soil improver which may be may be in the form of a solution, suspension of metal ions, gel, for example with the use of a gelling agent, or a dried preparation such as a powder, granules or pellets.

The nutrient additive of the present invention may be incorporated into fertilizers to supplement the nutrient levels. The additives, fertilisers or soil improvers of the present invention are particularly advantageous for adding metal ions and metal compounds and/or trace elements to preparations, for example fertilisers, slurry and soil improvers, that will be put onto the land and therefore the nutrient additive of the present invention is particularly advantageous for increasing the amount of metal ions, compounds and/or trace elements in soil. This is particularly advantageous because many agricultural soils are depleted in metal ions, metal compounds and trace elements due to intensive agriculture and these compounds are often not included in high enough levels in prior art fertilisers to improve the soil nutrient levels.

Electronic waste, in the present invention, may comprise or consist of batteries, circuit boards from electronic equipment, wiring, and/or other electronic components comprising suitable metals. Suitable metals can include those required for plant and/or animal health: for example, primarily N, P, and K, secondary Ca, Mg, and S, micro nutrients, such as Co, Mn, Cu, Zn, Mn, Se, B, and F, and other trace elements. Electronic waste may also be called e-waste.

The electronic waste may be any electrical or electronic waste, including batteries, that comprises metals that are required in a fertiliser or depleted in agricultural land, such as N, P, K, Ca, Mg, S, Co, Mn, Cu, Zn, Mn, Se, B, and F, or combinations thereof. In one embodiment, the electronic waste comprises metal consisting or comprising any of Zn, Mn, Co, Fe, Mo, and Cu, or combinations thereof. For example the electronic waste may comprise or consist of any used or unused battery or parts of a battery. Electronic waste may comprise any size of battery, for example: lantern, 6-volt, 4.5-volt, D, C, AA, AAA, AAAA, A23, 9-volt, CR2032 and LR44, PP and/or obsolete A & B sizes. Electronic waste may comprise any type of batteries, for example alkaline, lithium ion, nickel cadmium, nickel-metal hydride and/or lithium polymer. In one embodiment, the electronic waste comprises or consists of battery types selected from alkaline battery, lithium ion battery, nickel cadmium battery, nickel-metal hydride battery and lithium polymer battery, or combinations thereof. The battery may be the whole battery, or parts thereof.

Electronic waste may comprise circuit boards from electronic equipment, wiring, batteries and/or other components comprising suitable metals (for example, as described herein). Advantageously, the electronic equipment may comprise or consist of batteries.

The electronic waste may not comprise high levels of toxic metals such as cadmium, mercury, tin and lead. For example, the electronic waste may not comprise nickel cadmium batteries. Additionally or alternatively, the electronic waste may not comprise lead acid batteries. High levels of toxic metals means amounts of toxic metals, for example cadmium, tin, mercury and/or lead, that will lead to an additive with levels of toxic metals that may be harmful to plant or animal life if added to agricultural land. It may be possible to have small amounts of toxic metals such as cadmium, tin, mercury and/or lead in the electronic waste provided that the amount of other metals and trace elements is high enough that the toxic metals form only a trace amount in the final product. The trace amount may be less than 10 ppm once diluted by any final medium for application, e.g. slurry or fertiliser. For example, toxic metals such as lead, cadmium, tin and/or mercury may form less than 0.1% w/w of the additive or less than 0.01% w/w of the additive. The levels of toxic elements in the electronic waste (pre-processed) may be an amount that would result in insignificant/negligible levels (e.g. less than 10 ppm) in a final preparation/product, e.g. once diluted.

If the electronic waste comprises unwanted metals, such as toxic metals, they may be removed after dissolving the electronic waste in acid, by adding compounds that react with the toxic metals to form insoluble compounds and then separating the insoluble compounds from the liquid additive. Insoluble compounds may be separated from the liquid additive by any suitable method, for example filtration, centrifugation or sedimentation. Therefore in one embodiment, the method may further comprise a step of extracting one or more metals, such as toxic metals, from solution.

For example if the nutrient additive comprises more lead than required, the method of making the nutrient additive may comprise an additional step of precipitating excess lead by adding a sufficient amount of iodide salts or an iodide containing compound to the additive to convert the lead to lead iodide. As lead iodide is substantially insoluble it may be removed from the additive by any suitable method, e.g. by filtration, centrifugation or sedimentation.

The electronic waste may not be electronic waste comprising metals that are damaging to agricultural soils or considered pollutants. The electronic waste may not comprise compounds that are soluble in acid and damaging if added to agricultural soils or considered pollutants. Example damaging compounds include lead, cadmium, and arsenic. The term damaging may include an significant negative effect on one or more of wildlife, plants, such as crops and wildflower, humans, domestic or farm animals, soil structure, water table, air, or combinations thereof. The electronic waste may be sorted to ensure that the levels of certain metals in the final solution are suitable for adding to agricultural soils. For example the mixture of different types of electronic waste may be selected to provide suitable ratios of particular elements or low levels of particular elements. For example, the electronic waste may comprise a mixture of alkaline batteries (for their zinc and manganese content) and lithium ion batteries (for their cobalt).

The electronic waste may be dismantled to obtain suitable/desirable parts, comprising metals, for use in the present method. For example, excess plastic, glass, fabrics and/or wood may be removed before or after the process, the electronic waste may be used in the methods of the present invention. The electronic waste may be sized into pieces or processed whole. The electronic waste may be sized into pieces before being added to a reaction vessel or before admixing with one or more acids. Sizing the electronic waste is advantageous to allow the acid to reach all parts of the waste and also to speed up the reaction. The electronic waste may be sized into pieces less than 5 cm, less than 4 cm, less than 3 cm, less than 2 cm, less than 1 cm, less than 0.5 cm, less than 0.2cm, or less than 0.1 cm.

The acid used to dissolve the electrical waste may comprise any strong acid or combination of strong acids or mixtures thereof. A strong acid is understood to be an acid that completely ionizes (dissociates) in a solution of water. The acid may be, for example, nitric acid, hydrochloric acid or sulfuric acid or combinations of these acids. In one embodiment the acid is nitric acid.

One or more acids may be added to the electronic waste in a ratio of between 1:1 and 10000:1, between 1:1 and 500:1, between 1:1 and 50:1 or between 1:1 and 6:1 ratio. In one embodiment the acids may be added to the electronic waste in a ratio of about 5:1. The acid may be any strong acid or combination of acids that are able to dissolve metals. For example, the acid may be one or more of hydrochloric acid (HCl), hydroiodic acid (HI), hydrobromic acid (HBr), perchloric acid (HClO4), nitric acid (HNO3) and sulfuric acid (H2SO4). In one embodiment the acid may be nitric acid. Nitric acid is advantageous because it adds nitrogen, which is advantageous in a fertiliser, to the additive, fertiliser or soil enhancer. In one embodiment nitric acid may be added to the electronic waste in a ratio of about 5:1. The above ratios may be measured as w/w.

The concentration of the acid used may be between 10% to 100% w/w concentration, for example between 30% and 90% or about 50% w/w. In one embodiment 50% w/w nitric acid may be used.

The reaction mixture comprising the acids and the electronic waste may also comprise a metal catalyst. Any metal lower than iron in the electrochemical series may be used as the catalyst. For example, the metal catalyst may be Lead, Silver, Gold, Mercury or Copper. Copper is an advantageous catalyst owing to its low toxicity and benefit to the soil and plant and animal health. It may be advantageous to use copper as the catalyst as it adds copper compounds to the additive.

The metal catalyst used in the reaction may be any suitable metal, metal alloy or compound that contains copper, lead, gold or silver A suitable metal catalyst may be added to the reaction mixture to increase the reaction rate. A suitable amount of catalyst may be enough to increase the rate of reaction for example metal catalysts may be used in an amount of about 0.01-25% w/w of the electronic waste in the reaction mixture. The catalyst may be used at a rate of about 1-10% wiw of the electronic waste in the reaction mixture or 2-3% w/w of the electronic waste in the reaction mixture.

In one embodiment, the metal catalyst comprises or consists of an aqueous copper II catalyst. The metal catalyst may comprise copper (II) nitrate. In one embodiment, the reaction comprises the use of nitric acid and copper (II) nitrate as a catalyst.

Advantageously, aqueous nitric acid dissolves copper metal or dissolves soluble copper compounds to form Cu²⁺_{(aq)}. This aqueous copper II ion displaces iron, for example in the steel shell of a battery, via the following reaction Cu²⁺_{(aq)}+Fe₍ₛ₎→Cu₍ₛ₎+Fe²⁺_{(aq)}. This displacement reaction enables steel battery casings to be dissolved exposing the contents to the acid to dissolve. Solid copper catalyst can be used with nitric acid as copper will react with nitric acid unlike sulfuric or most other acids. In particular, using nitric acid with copper catalysts enables the entire battery to be dissolved, including the steel casing (not just the contents). The steel casing contains valuable elements for improved soil health such as Iron, Molybdenum, nickel and chromium and also in dissolving the casing avoids waste. Advantageously, the process can be used for any battery whether that be lithium ion, Zinc/Manganese.

The reaction between electronic waste and acids may be carried out at a temperature that is high enough to keep the rate of reaction sufficiently fast, for example at least about 65° C. or at least about 70° C. For example a temperature that is high enough to allow the reaction to be completed, i.e. the metals to be dissolved, within less than 20 minutes, 30 minutes, 1 hour, 2 hours, 4 hours, 8 hours, 12 hours 24 hours or 48 hours. The reaction may be carried out at a temperature at which the acid is liquid. For example, the temperature may be between −10° C. and 130° C. In one embodiment the reaction may be carried out at a temperature of about 60° C. In one embodiment the reaction may be carried out at a temperature of about 70° C. The reaction may be carried out at a temperature of at least 65° C. or at least about 70° C. The reaction may be carried out at a temperature of between about 65° C. and about 150° C. The reaction may be carried out at a temperature of between 65° C. and 130° C. The reaction may be carried out at a temperature of between 65° C. and 120° C. The reaction may be carried out at a temperature of between 70° C. and 120° C.

During the reaction, for example step b, the reaction mixture may be heated to between 0° C. and 100° C. to increase the rate of reaction, or preferably be heated to 60° C. The digestion mixture may not require heating as the exothermic reactions may generate enough heat to dissolve the electronic waste and push the reaction to completion.

The reaction step, for example step b, may be carried out for between 1 minutes and 24 hours, for between 1 hour and 12 hours, or for about 2 hours. The metal catalysts, acids and electronic waste may be added in any order. The reaction may be considered completed when the majority of the acid-soluble metals in the electronic waste are dissolved. For example when greater than 80%, greater than 90%, greater than 95%, greater than 99% or 100% of the acid-soluble metals in the electronic waste have been dissolved.

During the reaction, for example step b, the reaction mixture may be agitated or mixed. The mixing may comprise, for example, mechanical stirring or mixing using a recirculating pump. In another embodiment, the reaction mixture may not be mixed as exothermic energy generated by the reaction creates sufficient convection currents to circulate the acid and dissolved catalyst.

During the reaction step, for example step b, additional metal or mineral wastes may be added to the reaction mixture to supplement the solution for example selenium, boron or compounds of these elements may be added. Suitable additional metal or minerals may be added to increase the levels of specific metals or minerals in the final additive or to balance out the amount of one metal or mineral in the final additive.

The method may comprise a separation step to separate insoluble material from the reaction mixture. The separation step may comprise filtration to remove solid pieces, for example pieces of insoluble plastic and/or the separation step may comprise skimming to remove floating insoluble debris and plastic. Insoluble material separated from the reaction mixture during the separation step may be subjected to further acid treatment to dissolve any remaining metals or may be entered into further processing, for example recycling or burning.

After the dissolving step and optionally removing insoluble material the liquid may be considered a nutrient additive that can be sold or used directly, for example by adding it to agricultural land, slurry, fertiliser, soil improvers, organic wastes such as farm yard manure, pig water, compost waste, chicken litter, dung heaps, human sewage, animal by-products, domestic food waste, water treatment solid wastes and/or dog excrement.

Alternatively one or more further ingredients may be added to the nutrient additive to change the properties of the nutrient additive for different uses or to make the nutrient additive into a different product such as a fertiliser. Different further ingredients may be added in order to make the nutrient additive into an additive for different uses, for example a fertiliser additive, a slurry additive or a soil improver additive. Different ingredients may be added to make the nutrient additive into a fertiliser or a soil improver.

One or more solid or liquid ingredients may be added to the nutrient additive to change the properties or to convert it into a different product. For example further acids may be added to reduce the pH. Alkali ingredients may be added to increase the pH. The pH may be adjusted to near neutral for some applications. For some application it may be advantageous for the additive to have a high or a low pH. A high pH may be considered to be pH>9, and a low pH may be considered to be pH<3. The nutrient additive may be diluted with water to reduce the concentration of metals and trace elements in the nutrient additive. The nutrient additive may be concentrated, for example by evaporation, to increase the concentration of metals and trace elements in the nutrient additive.

Liquid ingredients may be added to the nutrient additive to change the properties of the nutrient additive or to make it into a liquid fertiliser or liquid soil improver. Liquid ingredients may, for example, be solutions of potassium, sodium, sulphur, magnesium, nitrogen and/or phosphorus compounds, organic carbon compounds or organic wastes, or combinations thereof. Liquid ingredients may also be water, acids, sulphuric acid, salts, thickeners, bleaches, colouring agents, deodorisers, fertilisers, preservatives or other ingredients that are commonly used in fertilisers and soil improvers, or combinations thereof.

Solid ingredients may be added to the nutrient additive to change the properties of the nutrient additive or make it into a solid fertiliser or solid soil improver. The solid ingredients may be powders, granules, pellets etc. The solid ingredients may be powders, granules, pellets of a compound such as a metal carbonate, metal oxide or metal hydroxide to both neutralise and set e.g. calcium oxide, calcium hydroxide or calcium carbonate. Additionally or alternatively, a compound such as calcium sulfate hemi-hydrate (plaster of paris to set) or cement.

One or more setting agents may be added to the nutrient additive. These may be gelling agents such as pectin, agar or gelatine. The pH of the additive may need to be adjusted before adding gelling agents. Gelling agents may be added to form the nutrient additive into a gel or gel beads. A setting agent such as plaster of Paris (CaSO4.0.5H2O), chalk, dolomite or other metal carbonate compound, or lime—(calcium hydroxide and/or Calcium Oxide) may be added to the nutrient additive to set it so that it can be granulated or formed into a powder. The nutrient additive may be added to a fertiliser or other fertiliser ingredients and then a setting agent, for example gypsum, plaster of Paris or lime (calcium hydroxide and/or Calcium Oxide), added to form a powdered or granulated fertiliser or soil improver.

A small amount of the nutrient additive may be added to a fertiliser, either during the process of making the fertiliser or the additive may be added to the final fertiliser product. The fertiliser comprising the nutrient additive may be set. The nutrient additive may be added into the fertiliser at the beginning of the process of making the fertiliser or during the process, for example, before the fertiliser is set so that the additive is set within the fertiliser.

The nutrient additive may be used as a slurry additive. The nutrient additive may be diluted using water or sulfuric acid to reduce the acidity somewhat before use as a slurry additive. This is advantageous because it makes it safer to handle.

Hydrogen and nitrous oxide gases may be produced by the reaction mixture and may be captured for use in further uses or processes.

After the chemical reaction is completed the acidic solution of metal ions may be further acidified by the addition strong acids for example sulfuric, nitric or hydrochloric acid.

The nutrient additive of the present invention may comprise a high/significant level of zinc, manganese, potassium, copper cobalt and iron compounds, or combinations thereof. For example, the additive solution may comprise about 1-30% or 1-10% or 3%-6% w/v dissolved metal salts.

The present method for production of a nutrient additive may further comprise any one or more features of the embodiments of the invention described herein.

The reaction vessel may be any type of reaction vessel that is suitable to withstand the acidic dissolving step without damage. The reaction vessel may be made of plastic, acid-resistant steel, or other acid resistant metal/alloy. Some grades of stainless steel would be suitable such as stainless steels containing copper and molybdenum, or zirconium or tantalum. The reaction vessel may be glass-lined. The reaction vessel may be open or covered. A covered reaction vessel may be arranged to comprise a mixing mechanism and/or a filtration mechanism and/or may have a means of removing waste gasses so that they can be re-used or disposed of safely.

The present method advantageously provides a rapid and efficient method of making nutrient rich additives, fertilizers and soil improvers which recovers all minerals from discarded batteries, or other electronic waste, and produces a highly available source of soluble minerals for the phytobiome. Notwithstanding the recycling benefits of removing potentially harmful batteries, or other electronic waste, from other means of disposal.

The present method advantageously provides a cost effective method of supplementing fertilizers and other soil treatments. Recycling batteries, or other electronic waste, also intercepts the conventional route to disposal with social environmental and moral benefits; converting them into valuable nutrient fertiliser additives and reduces waste.

In a second aspect the present invention provides a nutrient additive made by the method of the present invention.

In a third aspect the present invention provides a use of electronic equipment for making an additive, a fertiliser or a soil improver. Advantageously, the electronic equipment may be batteries.

The “nutrient additive” may otherwise be understood to be a fertilise, an additive to a fertilise, a soil improver, or an additive to a soil improver.

The skilled person will understand that optional features of one embodiment or aspect of the invention may be applicable, where appropriate, to other embodiments or aspects of the invention.

The invention is now described with reference to the following specific embodiments and accompanying drawings in which:

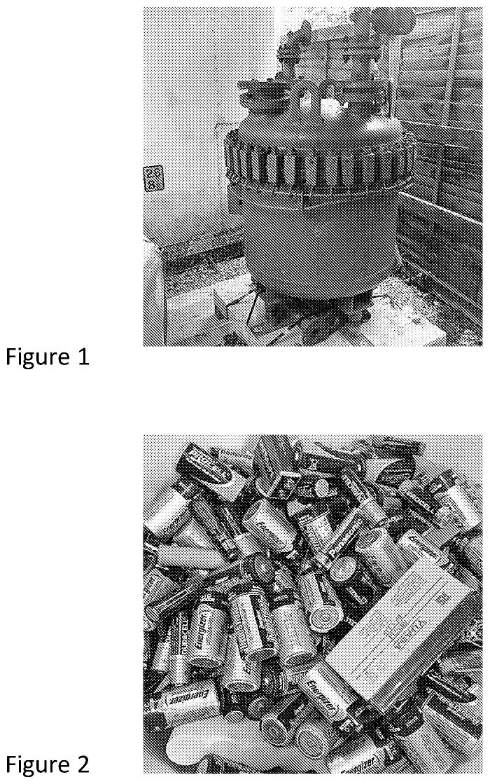

FIG. 1: shows an example of a reaction vessel that the reaction to dissolve batteries in acid may take place in.

FIG. 2: shows examples of batteries that may be dissolved in the present invention,

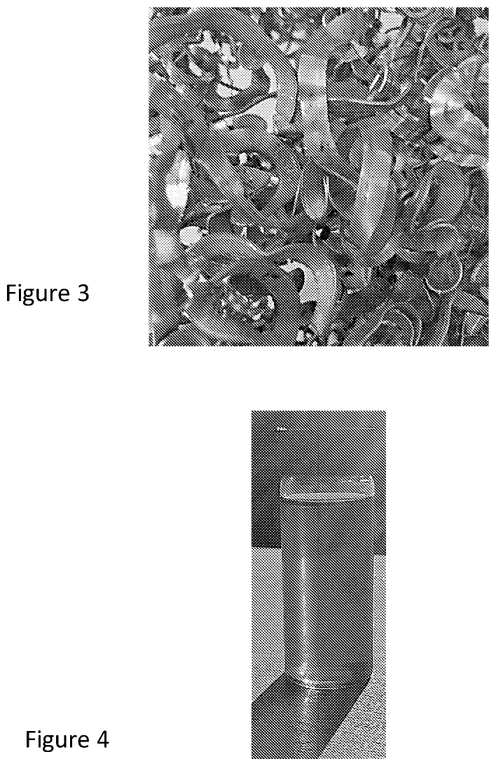

FIG. 3: shows an example of a metal catalyst that may be used in the present method, in this case the metal catalyst is copper turnings, which are a waste product from industry,

FIG. 4: shows the liquid additive after the dissolving step and filtration to remove undissolved solids such as plastics. This may be used directly as a fertiliser and/or soil improver and/or additive solution,

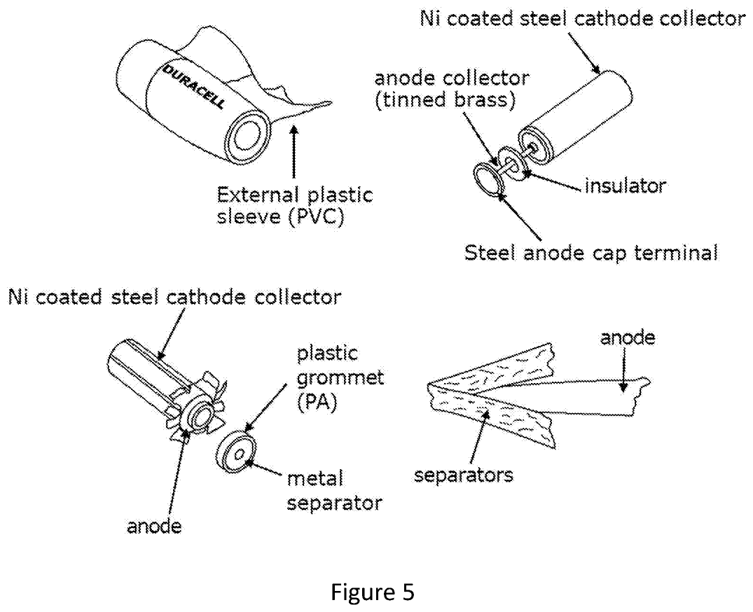

FIG. 5: shows an example of the structure of a battery: top left shows an orthogonal view of the battery with some of the external plastic sleeve peeled back; Top right shows an exploded view of a battery showing the steel anode cap terminal, anode collector made of tinned brass, the insulator and the Nickel coated steel cathode collector; Bottom left shows an exploded view of a battery showing the metal separator, plastic grommet, anode and nickel coated steel cathode collector; Bottom right shows the separators from inside a battery.

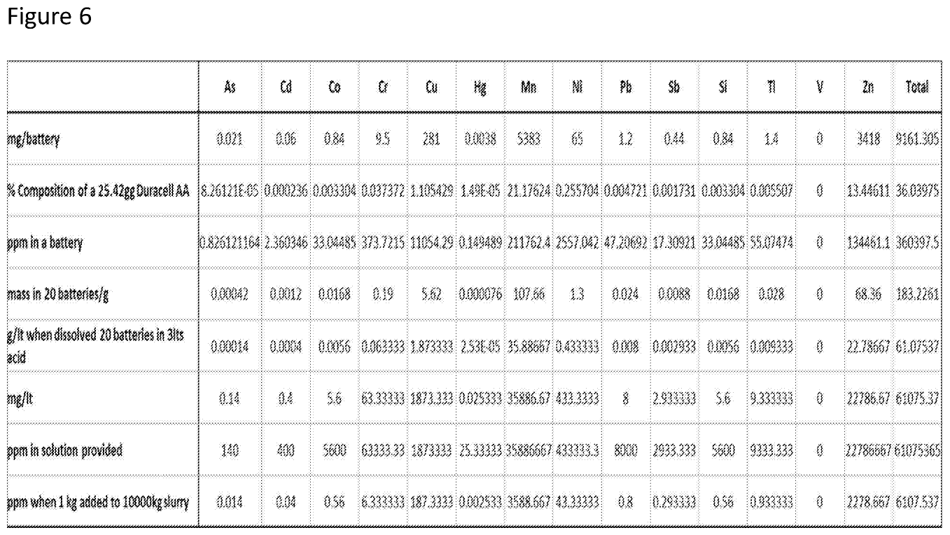

FIG. 6: provides the contents of nutrient additive solution containing a range of metals and trace elements as obtained from batteries and added to slurry.

Dissolving batteries in acids with a metal catalyst produces a mineral rich solution for incorporation into fertilisers and soil improvers.

Method

Batteries are added to the reaction vessel with premixed copper catalyst

Acid is added to the batteries in a reaction vessel

Additional minerals are added if required

Finishing of the Product

The nutrient additive may be neutralised by a suitable neutralising medium before application to soil

### EXAMPLE 1

500 g Batteries were mixed with 3000 ml of 50% nitric acid with 2-5% of the battery mass of copper catalyst (10-25 g copper metal). These can be mixed in any order. The mixtures was left for 120 mins without stirring. The mixture may be stirred to increase the reaction rate. Insoluble plastics and paper impurities were separated by filtration. The resulting liquid containing metals dissolved in nitric acid was bottled.

The resulting liquid is very acidic and high in metal ions. Liquid was used directly as a fertiliser or soil improver by adding to the soil and by adding to slurry.

### EXAMPLE 2

The liquid from example 1 was added to sulfuric acid to make a slurry additive. Sulfuric acid is a cheap additive that was used to bulk out the liquid to produce a slurry additive that was very acidic but had a lower concentration of metals than the liquid produced in example 1.

### EXAMPLE 3

The liquid from example 1 was neutralised to about pH 6 by adding hydrogen peroxide pellets before applying to soil as a soil improver or fertiliser. The solution may also be neutralised by chalk or lime. The neutralised solution may be advantageous because it is less damaging if it directly touches plants than the acidic solution. It is also easier to handle because it is less acidic.

### EXAMPLE 4

The liquid from example I was diluted 1000 fold and 10000 by adding it to fertiliser to enrich the fertiliser.

### EXAMPLE 5

The method of example 1 was carried out using circuit boards and electronic scrap instead of batteries. This is advantageous because circuit boards and other electronic scrap contain different minerals and metals from those contained in batteries. It would also be possible to mix the liquids made by dissolving different types of electronic waste in order to produce a fertiliser or soil additive with a wider range of minerals, metals or trace elements or a particular balance of minerals, metals or trace elements for a particular indication.

### EXAMPLE 5

Additional compounds or metals could be added during the step of dissolving in acid to increase and make bio-available by dissolving elements such as selenium, boron, cobalt etc.

### EXAMPLE 6

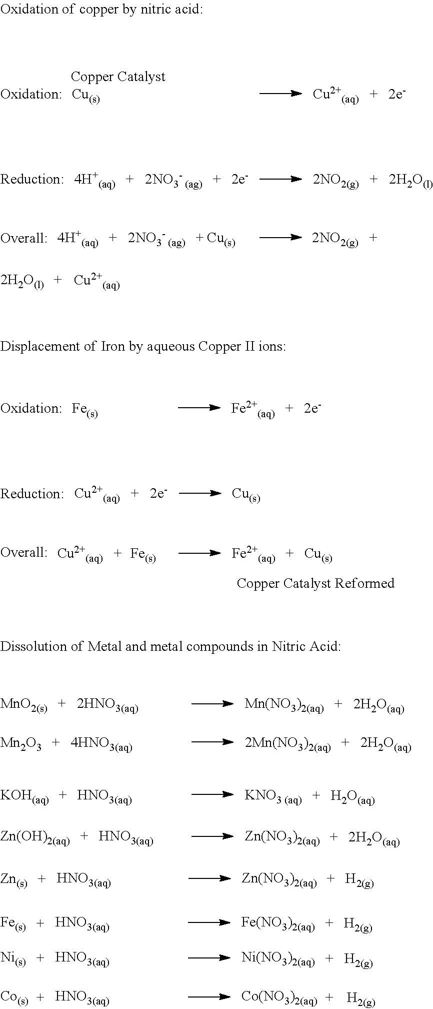

### EXAMPLE 7

Battery Trial

14/10/16

3 litres 50% Nitric Acid

20 Duracell alkaline AA batteries 25.42 g×20=508.4 g

10 g Cu for electrochemical displacement of Fe in battery shells

Warm to commence then self-sustaining.

2.9 litres solution containing a range of metals and trace elements. This solution was analysed and is described in table 3.

7 g plastic remaining (1.4% waste)

Research Paper Composition of Batteries

Second batch (White top bottles) also contain magnesium, selenium, boron, zinc, cobalt.

TABLE 1
Analysis of batteries

| | | Average dry weight^{b} | Moisture content^{b} | Ash content^{b} | Higher heating value^{b} | Lower heating value |
|---|---|---|---|---|---|---|
| Components | Base Material | (g per battery) | (%, dry basis) | (%, dry basis) | (kJ kg⁻¹, dry basis) | (kJ kg⁻¹, dry basis) |
| Anode cap | Steel | 0.288 ± 0.003 | — | — | — | — |
| Insulator | Cardboard | 0.060 ± 0.002 | 6.4 ± 0.1 | 9.3 ± 0.5 | 23.8 × 10³ ± 0.4 × 10³ | 22,675 |
| Plastic grommet | Polyamide (PA) | 0.215 ± 0.005 | 1.4 ± 0.2 | 1.0 ± 0.3 | 35 × 10³ ± 2 × 10³ | 33,041 |
| Metal separator | Steel | 0.377 ± 0.005 | — | — | — | — |
| Anode collector | Tin-plated brass | 0.438 ± 0.004 | — | — | — | — |
| Anode | Zn + ZnO + KOH | 3.86 ± 0.05 | 1.8-28.7 | 99 ± 1 | 6.1 × 10³ ± 0.7 × 10³ | 6142 |
| Separator | Paper | 0.107 ± 0.009 | 5 ± 1 | 2.4 ± 0.2 | 26 × 10³ ± 2 × 10³ | 25,008 |
| | Cellophane | 0.045 ± 0.003 | 10 ± 1 | 5.26 ± 0.06 | 22.09 × 10³ ± 0.7 × 10³ | 20,857 |
| Cathode | MnO₂ + C + KOH | 11.9 ± 0.9 | 8 ± 2 | 88.3 ± 0.4 | 6.8 × 10³ ± 0.8 × 10³ | 6799 |
| Cathode collector | Steel | 4.01 ± 0.05 | — | — | — | — |
| Plastic sleeve | Polyvinylchloride (PVC) | 0.23 ± 0.01 | 1.7 ± 0.2 | 5.8 ± 0.08 | 20.4 × 10³ ± 0.9 × 10³ | 19,455 |
| Entire batteries | — | 23.5^{a} ± 0.4 | — | 98.1 ± 0.2 | — | — |

—, not determinded.
^{a}As collected.
^{b}95% confidence interval.

TABLE 2
Table 4
Concentration of heavy metals in battery components [symbol] of dry [symbol] , except for Hg and As, expressed as [symbol] .

| | | | | | | | | | | | | | | | Total |
|---|---|---|---|---|---|---|---|---|---|---|---|---|---|---|---|
| Metals | | | | | | | | | | | | | | | (mg per |
| components | As | Cd | Co | Cs | Cu | Hg | Mn | Ni | Pb | Sb | Si | Tl | V | Zn | battery) |
| Anode cap | 4.7 | < [symbol] 11 | [symbol] .11 | 0.96 | [symbol] | — | 2.1 | 14.3 | 0.16 | <DL | — | <DL | <DL | 0.009 | 3.3 |
| | 6.3 | [symbol] 7 | [symbol] .12 | 1.1 | <DL | | 2.3 | 16.4 | 0.18 | | | | | 0.30 | |
| Insulator | <DL | <DL | <DL | <0.082 | <DL | — | < [symbol] | <0.11 | 0.22 | <DL | — | <DL | <DL | <0.022 | 0.065 |
| | | | | 0.11 | | | [symbol] | 1.4 | 0.44 | | | | | 0.40 | |
| Plastic | <DL | <DL | <DL | 0.028 | <DL | — | [symbol] | <0.029 | 0.079 | <DL | — | <DL | <DL | 0.051 | 0.19 |
| grommet | | | | 0.035 | | | [symbol] | [symbol] | [symbol] | | | | | 1.1 | |
| Metal | 3.7 | | 0.087 | 2.4 | 0.072 | — | 2.2 | 0.19 | 0.15 | <DL | — | <DL | <DL | 0.005 | 2.1 |
| separator | 7.1 | [symbol] 12 | 0.12 | 2.6 | [symbol] .14 | | [symbol] | 0.23 | 0.17 | | | | | 0.045 | |
| Anode | <DL | <DL | <DL | <0.052 | 589 | — | <DL | <0.015 | 0.046 | <DL | — | <DL | <DL | 317 | 428 |
| collector | | | | 0.022 | 692 | | | [symbol] | 0.069 | | | | | 365 | |
| Anode | [symbol] 6.633 | <DL | <DL | <DL | <DL | <DL | 0.011 | <DL | 0.047 | <DL | — | <DL | <DL | 792 | 3154 |
| | 0.11 | | | | | | 0.025 | | 0.049 | | | | | 830 | |
| Separator | <DL | <DL | <DL | , [symbol] | <DL | — | 0.73 | <DL | 0.14 | <DL | — | <DL | <DL | 13.6 | 2.4 |
| paper | | | | 0.30 | | | 2.87 | | 0.63 | | | | | 35.8 | |
| Cellophane | <DL | <DL | <DL | <0.14 | <DL | — | 6.16 | <DL | <0.26 | <DL | — | <DL | <DL | 13.8 | 2.0 |
| | | | | 0.44 | | | 8.37 | | 0.83 | | | | | [symbol] | |
| Cathode | 0.065 | <DL | 0.027 | [symbol] | <DL | <0.11 | 453 [symbol] | 0.018 | <0.011 | <DL. | — | 0.084 | <DL | 9. [symbol] | 5487 |
| | 0.11 | | 0.029 | 0.008 | | 0.43 | | 0.030 | 0.0052 | | | 0.097 | | 10. [symbol] | |
| Cathode | 2.8 | [symbol] | [symbol] | 2. [symbol] | 0.065 | — | 2 [symbol] | 13.9 | 0.0087 | 0.095 | < [symbol] | 0.076 | <DL | 0.034 | 80 |
| collector | 5.0 | 0.015 | 0.12 | 2.1 | [symbol] | | [symbol] | 16.2 | 0.0094 | 0.12 | 0.41 | 0.093 | | 0.073 | |
| Plastic | <DL | <DL | <DL | < [symbol] | < [symbol] | — | < [symbol] | [symbol] | <0.10 | <DL | | <DL | <DL | <0.013 | 0.19 |
| sleeve | | | | 0.40 | [symbol] | | #,899; | 0.18 | 0.12 | | | | | 0.47 | |
| Battery | 0.021 | 0.060 | [symbol] | 9.5 | 281 | 0.0038 | 5382 | 66 | 1.2 | 0.44 | [symbol] | 1.4 | [symbol] | [symbol] | 9163 |
| total amount | | | | | | | | | | | | | | | |
| (mg per | | | | | | | | | | | | | | | |
| battery) | | | | | | | | | | | | | | | |

<DL, below detection limit.
—, not determined. [symbol]
Determined by [symbol]
M. E. [symbol] et al.: Waste Management [symbol] [symbol]
indicates data missing or illegible when filed

TABLE 3
BATCH 290 MB/RD NITRIC ACID SOLUTIONS FOR TRACE METAL ANALYSES
SAMPLES RUN ON 26.10.16. DATA RECORDED IN LN 7007
RESULTS ARE REPORTED AS PPM IN SOLUTION (CORRECTED FOR 100X DILUTION)

| | Al | As | Ca | Cd | Co | Cr | Cu | Fe | K | Mg |
|---|---|---|---|---|---|---|---|---|---|---|
| | 396.153 | 188.979 | 315.887 | 228.802 | 228.616 | 267.716 | 327.393 | 238.204 | 766.490 | 279.077 |
| 290/1 | 3.585 | 8.437 | 7.505 | −0.095 | 111.709 | 1.960 | 2260.336 | 3223.445 | 541.408 | −15.651 |
| 290/2 | 2.820 | 8.515 | 7.747 | −0.114 | 112.529 | 1.984 | 2292.923 | 3308.522 | 551.593 | −16.831 |
| 290/3 | 3.528 | 8.997 | 7.378 | −0.132 | 113.666 | 1.979 | 2308.214 | 3287.549 | 549.631 | −17.020 |
| | CORRECTED FURTHER FOR 10X DILUTION | | | | | | | | | |
| Raw | Al | As | Ca | Cd | Co | Cr | Cu | Fe | K | Mg |
| Solution | 396.153 | 188.979 | 315.887 | 228.802 | 228.616 | 267.716 | 327.393 | 238.204 | 766.490 | 279.077 |
| 290/1 | 35.9 | 84.4 | 75.0 | −0.9 | 1117.1 | 19.6 | 22603.4 | 32234.5 | 5414.1 | −156.5 |
| 290/2 | 28.2 | 85.1 | 77.5 | −1.1 | 1125.3 | 19.8 | 22929.2 | 33085.2 | 5515.9 | −168.3 |
| 290/3 | 35.3 | 90.0 | 73.8 | −1.3 | 1136.7 | 19.8 | 23082.1 | 32875.5 | 5496.3 | −170.2 |
| Mean PPM | 33.1 | 86.5 | 75.4 | −1.1 | 1126.3 | 19.7 | 22871.6 | 32731.7 | 5475.4 | −165.0 |
| % | 0.003 | 0.009 | 0.008 | 0.000 | 0.113 | 0.002 | 2.287 | 3.273 | 0.548 | −0.017 |
| Prepared | Dilluted 10x by further adding to 50% sulfuric acid(1.41 sg) by elementral Digest | | | | | | | | | |
| Solution | | | | | | | | | | |
| 290/1 | 3.59 | 8.44 | 7.50 | −0.09 | 111.71 | 1.96 | 2260.34 | 3223.45 | 541.41 | −15.65 |
| 290/2 | 2.82 | 8.51 | 7.75 | −0.11 | 112.53 | 1.98 | 2292.92 | 3308.52 | 551.59 | −16.83 |
| 290/3 | 3.53 | 9.00 | 7.38 | −0.13 | 113.67 | 1.98 | 2308.21 | 3287.55 | 549.63 | −17.02 |
| Mean PPM | 3.31 | 8.65 | 7.54 | −0.11 | 112.63 | 1.97 | 2287.16 | 3273.17 | 547.54 | −16.50 |
| | Then Dilluted *1000 when added at 1 kg per tonne slurry | | | | | | | | | |
| | Al | As | Ca | Cd | Co | Cr | Cu | Fe | K | Mg |
| 290/1 | 0.004 | 0.008 | 0.008 | 0.000 | 0.112 | 0.002 | 2.260 | 3.223 | 0.541 | −0.016 |
| 290/2 | 0.003 | 0.009 | 0.008 | 0.000 | 0.113 | 0.002 | 2.293 | 3.309 | 0.552 | −0.017 |
| 290/3 | 0.004 | 0.009 | 0.007 | 0.000 | 0.114 | 0.002 | 2.308 | 3.288 | 0.550 | −0.017 |
| Mean PPM | 0.003 | 0.009 | 0.008 | 0.000 | 0.113 | 0.002 | 2.287 | 3.273 | 0.548 | −0.017 |
| % | | | | | | | | | | |
| | Mn | Mo | Na | Ni | P | Pb | S | Se | Ti | Zn |
| | 257.610 | 202.031 | 589.592 | 231.604 | 213.617 | 220.353 | 181.975 | 196.026 | 334.940 | 206.200 |
| 290/1 | 2741.747 | −0.492 | 9.053 | 842.017 | 60.927 | 1.739 | 12.029 | 2.090 | 0.158 | 2862.354 |
| 290/2 | 2811.855 | −0.503 | 1.564 | 860.193 | 71.359 | 1.595 | 12.044 | 0.670 | 0.123 | 2968.696 |
| 290/3 | 2824.696 | −0.422 | −2.885 | 865.315 | 70.256 | 1.816 | 12.634 | 2.635 | 0.170 | 2948.690 |
| Raw | Mn | Mo | Na | Ni | P | Pb | S | Se | Ti | Zn |
| Solution | 257.610 | 202.031 | 589.592 | 231.604 | 213.617 | 220.353 | 181.975 | 196.026 | 334.940 | 206.200 |
| 290/1 | 27417.5 | −4.9 | 90.5 | 8420.2 | 609.3 | 17.4 | 120.3 | 20.9 | 1.6 | 28623.5 |
| 290/2 | 28118.5 | −5.0 | 15.6 | 8601.9 | 713.6 | 15.9 | 120.4 | 6.7 | 1.2 | 29687.0 |
| 290/3 | 28247.0 | −4.2 | −28.8 | 8653.1 | 702.6 | 18.2 | 126.3 | 26.3 | 1.7 | 29486.9 |
| Mean PPM | 27927.7 | −4.7 | 25.8 | 8558.4 | 675.1 | 17.2 | 122.4 | 18.0 | 1.5 | 29265.8 |
| % | 2.793 | 0.000 | 0.003 | 0.856 | 0.068 | 0.002 | 0.012 | 0.002 | 0.000 | 2.927 |
| Prepared | | | | | | | | | | |
| Solution | | | | | | | | | | |
| 290/1 | 2741.75 | −0.49 | 9.05 | 842.02 | 60.93 | 1.74 | 207195.70 | 2.09 | 0.16 | 2862.35 |
| 290/2 | 2811.85 | −0.50 | 1.56 | 860.19 | 71.36 | 1.59 | 146950.82 | 0.67 | 0.12 | 2968.70 |
| 290/3 | 2824.70 | −0.42 | −2.88 | 865.31 | 70.26 | 1.82 | 146951.41 | 2.63 | 0.17 | 2948.69 |
| Mean PPM | 2792.77 | −0.47 | 2.58 | 855.84 | 67.51 | 1.72 | 167032.64 | 1.80 | 0.15 | 2926.58 |
| | Mn | Mo | Na | Ni | P | Pb | S | Se | Ti | Zn |
| 290/1 | 2.742 | 0.000 | 0.009 | 0.842 | 0.061 | 0.002 | 207.196 | 0.002 | 0.000 | 2.862 |
| 290/2 | 2.812 | −0.001 | 0.002 | 0.860 | 0.071 | 0.002 | 146.951 | 0.001 | 0.000 | 2.969 |
| 290/3 | 2.825 | 0.000 | −0.003 | 0.865 | 0.070 | 0.002 | 146.951 | 0.003 | 0.000 | 2.949 |
| Mean PPM | 2.793 | 0.000 | 0.003 | 0.856 | 0.068 | 0.002 | 167.033 | 0.002 | 0.000 | 2.927 |
| % | | | | | | | | | | |

1. A method of making a nutrient additive from electronic waste comprising the steps of:
a) adding electronic waste to a reaction vessel;
b) admixing the electronic waste and optionally one or more metal catalysts with one or more acids,
wherein one or more metals in the electronic waste is dissolved by the acid to form a nutrient additive.

2. The method according to claim 1, wherein the catalyst is any one or more metals that are lower than iron in the electrochemical series or compounds or alloys thereof.

3. The method according to claim 1, further comprising a separation step, after step b, wherein insoluble material, such as plastic is removed.

4. The method according to claim 1, further comprising a step, after step b, of adjusting the acidity by further additions of acids or alkalis.

5. The method according to claim 1, further comprising a step, after step b, of diluting the nutrient additive.

6. The method according to claim 1, further comprising a step, after step b, of concentrating the nutrient additive.

7. The method according to claim 1, further comprising a step, after step b, of adding further liquid ingredients to the nutrient additive.

8. The method according to claim 1, further comprising a step, after step b, of adding further liquid ingredients to the nutrient additive.

9. The method according to claim 1, further comprising a step, after step b, of adding one or more setting agents to set the nutrient additive so that it can be powdered or granulated.

10. The method according to claim 9 wherein the setting agent comprises or consist of one or more agents selected from: plaster of Paris (CaSO4 0.5H2O), chalk, dolomite or other metal carbonate compound, calcium hydroxide and calcium oxide.

11. The method according to claim 1, wherein the nutrient additive is added to a fertilizer, during manufacturing of the fertilizer, and the fertilizer is then set using plaster of Paris.

12. The method according to claim 1, wherein the catalyst is metallic lead, copper, gold, or sifter or compounds or alloys containing these metals.

13. (canceled)

14. A nutrient additive made by the method of claim 1.

15. A fertilizer or soil improver comprising a nutrient additive obtained or obtainable by the method of claim 1.

16. A method of fertilizing or improving soil comprising:
I. making a nutrient additive from electronic waste comprising the steps of:
a) adding electronic waste to a reaction vessel, said electronic waste comprising one or more metals;
b) admixing said electronic waste with one or more acids, thereby dissolving said one or more metals by said one or more acids to form a nutrient additive; and
II. adding said nutrient additive to soil, thereby fertilizing or improving the soil.

17. (canceled)

18. (canceled)

19. (canceled)
